(19) United States
(12) Patent Application Publication
(10) Pub. No.: US 2010/0112111 A1
(43) Pub. Date: May 6, 2010

(54) DEVICE FOR THE PRODUCTION OF MULTI-LAYER TUBES

(75) Inventors: Gerd Gosmann, Pfaffenhofen (DE); Achim Neubauer, Vierkirchen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: KraussMaffei Technologies GmbH, München (DE)

(21) Appl. No.: 12/593,364

(22) PCT Filed: Mar. 20, 2008
(86) PCT No.: PCT/EP08/53419

§ 371 Date: Sep. 28, 2009

(30) Foreign Application Priority Data
Mar. 29, 2007 (DE) 10 2007 015 065.4

(51) Int. Cl. B29C 47/06; B29C 47/90

(52) U.S. Cl. 425/133.1

(57) ABSTRACT

A device for the production of multi-layer tubes (A), in particular foam core tubes, with an extruder arrangement (1), wherein the extruder arrangement (1) includes at least two extruders (2,3) for the production of melt, with at least one tube head (4) for forming the melt and with at least one calibration basket (5) to set the shaping and with at least one outlet (6) for transporting the produced multi-layer tube (A) is embodied and further developed with regard to a particularly favourably-priced production such that the calibration basket (5) is adjustable in diameter, so that the multi-layer tubes are changeable in their dimension in continuous operation.

The invention relates to a device for the production of multi-layer tubes, in particular foam core tubes with an extruder arrangement, wherein the extruder arrangement comprises at least two extruders for the production of melt, with at least one tube head for forming the melt and with at least one calibration basket to set the shaping and at least one outlet for transporting the produced multi-layer tube.

Devices for the production of foam layer tubes, in particular of foam core tubes, have been known from practice for a long time. In the known devices, melt is produced by means of two or more extruders. In at least one of the extruders, a foaming of the melt takes place by means of chemical or physical foams. In these devices, it is a problematical that multi-layer tubes with different external diameters and possibly with different wall thicknesses make it necessary to convert the device. To do this, generally the tube head and the calibration basket are exchanged. In the prior art, it is necessary here that corresponding tools have to be exchanged in accordance with the external diameter of the tube and the desired wall thickness of the tube, usually standardized as a function of the external diameter. This entails a shut-down of the machine, a great labour input for the exchange and a loss of plastic material, until the new multi-layer tube can be produced again with a sufficient quality.

From EP 1 115 550 B1 a device is known for the production of plastic tubes. This device comprises an extruder, an adjoining tube head in the production direction, and a calibration station which has calibration tools. These calibration tools lie against the outer wall of the tube for shaping. A plurality of plates which are adjustable in diameter are provided as the calibration tool.

The present invention is based on the problem of indicating a device for the production of multi-layer tubes of the type mentioned in the introduction, by which a simple processing is possible with a simple construction.

The above problem is solved according to the invention by a device for the production of multi-layer tubes with the features of Claim 1. According to this, the device in question for the production of multi-layer tubes is embodied and further developed such that the calibration basket is adjustable in diameter, so that the multi-layer tubes are able to be altered in their dimension during continuous operation.

The production of multi-layer tubes as foam core tubes is especially problematic, because these are particularly unstable. Too great a vacuum leads to the tearing of the outer wall and hence to the running out of the tube. Too weak a vacuum leads to a separating of the melt tube, so that the tube collapses on itself. The same also applies to the production of other multi-layer tubes. Hitherto, it has been assumed that owing to these difficulties, a change in diameter in continuous production of is not possible with multi-layer tubes. It has therefore been discovered in an inventive manner that in a departure from the previous assumption, one can use the known calibration basket for changing dimension in continuous operation. A simple processing with a simple construction is therefore made possible, whereby the advantages of the production of tubes with different dimensions are also able to be transferred to multi-layer tubes, in particular foam core tubes.

In a particularly advantageous manner, at least one extruder could have an arrangement to introduce, in particular, chemical propellants into the melt. The arrangement could be an arrangement, known from the prior art, for the introduction of propellant into the melt. Thereby, a particularly good foaming of the melt would be achieved, in particular with regard to the cell size and the distribution thereof. The use of any chemical propellant is possible here.

With regard to a particularly simple development, the change in dimension of the multi-layer tube could take place by a change to the diameter of the calibration basket and/or by changing the speed of the outlet.

The diameter of the multi-layer tube is determined by the alteration of the calibration basket. The alteration of the tube diameter is facilitated by an adaptation of the vacuum applied in the calibration basket. The adaptation of the vacuum could take place such that a tearing of the outer covering of the multi-layer tube and a separation of the tube from the calibration basket is avoided. The adaptation could take place by an automatic regulation, a control arrangement or manual adjustment. An automatic regulation would make it possible to be able to run the device fully automatically. The change in speed of the outlet makes it possible to adjust the thickness of the tube. In addition, the cell size can thus be controlled in the foamed material.

To increase the variability of the diameter of the multi-layer tube, a vacuum suction bell could be provided between the tube head and the calibration basket. By means of this vacuum suction bell, the melt emerging from the tube head would be expanded, whereby a greater dimension adjustment range would be made possible. In combination with a low melt viscosity, only a slight change of a suction bell vacuum would have a direct effect. With a slight vacuum reduction, on the other hand, the separation of the melt strand from the calibration would occur very quickly. A slight overrunning of the vacuum, on the other hand, would lead to the tearing of the outer covering of the multi-layer tube and hence to a running out of the multi-layer tube. A direct regulation of the vacuum suction bell would therefore be very advantageous. This regulation could likewise be embodied so as to be automated.

With regard to a particularly simple construction, the tube head could have a constant nozzle gap. Depending on the number of layers, the tube head would be supplied with melt from two or more different extruders. In the simplest case, such a multi-layer tube would include an inner layer of compact material, a middle layer of foamed material and an outer layer of, again, compact material.

Within the framework of a particularly good variability of the multi-layer tubes, the tube head could, however, also have a variable nozzle gap. Through the variability of the nozzle gap, the wall thickness of the multi-layer tube could then be regulated additionally or alternatively to outlet speed.

With regard to a particularly flexible setup of the device, the distance between the tube head and the calibration basket could be embodied so as to be changeable. Contrary to the adjustment strategy in a compact tube, it has been found that in the case of a foam core tube it is advantageous to increase the distance between the calibration and the tube head with a decreasing tube diameter. It has namely become recognized according to the invention that the foam melt, after leaving the tube head, requires a certain time for expanding. With a higher outlet speed with smaller tube diameters, this fact could be allowed for in that a greater distance can be adjusted between the nozzle and calibration. With greater diameters with their associated wall thicknesses, on the other hand, a smaller distance could be selected between nozzle and calibration basket. As a whole, it is therefore advantageous to increase the distance between tube head and calibration basket with a decreasing tube diameter.

With regard to a particularly simple production of a PVC foam core tube, the extruder arrangement could comprise a main extruder, for example for the production of PVC melt, and a coextruder, for example for the production of PVC melt. The two extruders could be embodied here for example as a double-worm extruder, wherein the main extruder in the simplest case could produce the foamed core of the tube and the coextruder could then produce the compact inner and outer layer of the multi-core tube.

In a particularly advantageous manner, the mass ratio could be between PVC foam 60% by weight and PVC 40% by weight. However, depending on the field of application, the mass ratio could also be PVC foam 70% by weight and PVC 30% by weight or PVC foam 50% by weight and PVC 50% by weight. In an additionally advantageous manner, the dimension change of the multi-layer tube could lie in the range of 90 mm to 140 mm and 110 mm to 160 mm. In addition, a feedblock system could be provided.

Various possibilities now exist for embodying and further developing the teaching of the present invention in an advantageous manner. To do this, on the one hand, reference is to be made to the claims subordinate to Claim 1, and on the other hand to the following explanation of a preferred example embodiment of a device according to the invention for the production of multi-layer tubes, with the aid of the drawings. Generally preferred embodiments and further developments of the teaching are explained in connection with the explanation of the preferred example embodiment of the device according to the invention for the production of multi-layer tubes with the aid of the drawings. In the drawings:

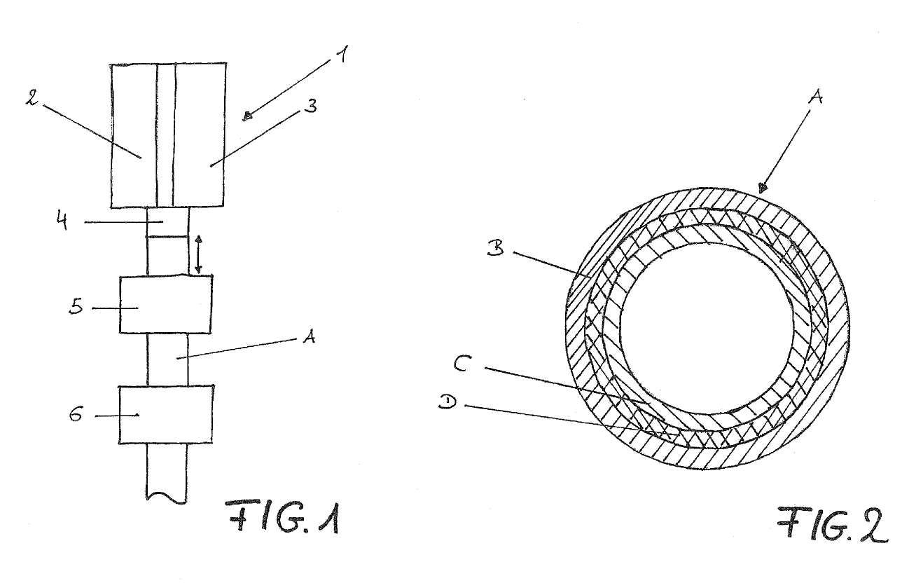

FIG. 1 shows in a diagrammatic illustration an example embodiment of a device according to the invention for the production of multi-layer tubes,

FIG. 2 shows in a diagrammatic illustration a cross-section of a multi-layer tube produced by the device of FIG. 1 according to the invention.

In FIG. 1 a device is shown for the production of multi-layer tubes, namely PVC foam core tubes, with an extruder arrangement 1. The extruder arrangement includes two extruders 2,3 which serve for the production of melt. By means of a tube head 4, a distribution takes place of the melt produced from the extruders 2,3 and a shaping thereof in tube form. In addition, a calibration basket 5 is provided, which serves to set the shaping. In addition, an outlet 6 is shown for the transport of the produced multi-layer tube. In accordance with the invention, the multi-layer tubes A are able to be altered in their dimension in continuous operation.

Both extruders are embodied as a double-worm extruder, wherein the main extruder 2 produces a PVC melt and the co-extruder 3 serves for the production of the unfoamed PVC melt. The tube head 4 has a constant nozzle gap. The alteration of the diameter of the multi-layer tube A and the adjustment of the wall thickness takes place by means of an alteration of the diameter of the calibration basket 5 and by the alteration of the speed of the outlet 6. In addition, the maximum adjustable wall thickness is reached by means of the distance between the nozzle of the tube head 4 and of the calibration basket 5.

FIG. 2 shows a multi-layer tube A with three layers. The outer layer B and the inner layer C are made of compact PVC, with the middle layer D including foamed PVC.

With regard to further details, reference is to be made to the general description, to avoid repetitions.

Finally, it is pointed out expressly that the example embodiment described above serves only for an explanation of the claimed teaching, but does not restrict this to the example embodiment.

### LIST OF REFERENCE NUMBERS

A multi-layer tube

B outer layer

C inner layer

D middle layer

1 extruder arrangement

2 main extruder

3 coextruder

4 tube head

5 calibration basket

6 outlet

1.-11. (canceled)

12. A device for production of a multi-layer tube, comprising:
an extruder arrangement having at least two extruders for production of a melt,
at least one tube head for forming the melt,
at least one calibration basket for adjusting a diameter of the multi-layer tube and for shaping the multi-layer tube, wherein a diameter of the at least one calibration basket is adjustable while the multi-layer tube passes through the at least one calibration basket and wherein a distance between the at least one tube head and the at least one calibration basket is adjustable depending on the diameter of the multi-layer tube, so that the diameter of the multi-layer tube can be changed during operation, and
at least one outlet for transporting the produced multi-layer tube.

13. The device according to claim 12, wherein at least one extruder further comprises an arrangement for introduction of a chemical propellant into the melt.

14. The device according to claim 12, wherein the change in dimension of the multi-layer tube is effected by a change in the diameter of the calibration basket or by the change of a transport speed of the at least one outlet.

15. The device according to claim 12, further comprising a vacuum suction bell disposed between the at least one tube head and the at least one calibration basket.

16. The device according to claim 12, wherein the at least one tube head has nozzle with a constant nozzle gap.

17. The device according to claim 16, wherein the nozzle gap is variable.

18. The device according to claim 12, wherein one of the at least two extruders is a main extruder, and another of the at least two extruders is a coextruder.

19. The device according to claim 12, wherein the melt is a PVC melt.

20. The device according to claim 12, wherein the multi-layer tube is a foam core tube.

21. The device according to claim 12, characterized in that a change in dimension of the multi-layer tube is in a range of 90 mm to 140 mm.

22. The device according to claim 12, characterized in that a change in dimension of the multi-layer tube is in a range of 110 mm to 160 mm.

23. The device according to claim 12, further comprising a feedblock system.

24. The device according to claim 18, wherein the multi-layer tube is a foam core tube, and the main extruder produces the foam core of the multi-layer tube and the coextruder produces a compact inner and outer layer of the multi-layer tube, with a mass ratio of the foam core to the inner and outer layer being between 60% to 40% by weight.

25. The device according to claim 24, wherein the foam core and the compact inner and outer layers are made of PVC.

26. The device according to claim 24, wherein the foam core and the compact inner and outer layer are made of micronized PVC.
